(19) United States
(12) Patent Application Publication
(10) Pub. No.: US 2024/0220876 A1
(43) Pub. Date: Jul. 4, 2024

(54) ARTIFICIAL INTELLIGENCE (AI) BASED DATA PRODUCT PROVISIONING

(71) Applicant: ACCENTURE GLOBAL SOLUTIONS LIMITED, Dublin 4 (IE)

(72) Inventors: Pragya SHARMA, Mumbai (IN); Ritu Pramod DALMIA, Mumbai (IN); Manish BACHHANIA, Khirkiya (IN); Priya DAS, Bangalore (IN); Aniruddha RAY, Bangalore (IN); Teresa Sheausan TUNG, Los Angeles, CA (US); Soubhagya MISHRA, Bhubaneswar (IN)

(73) Assignee: ACCENTURE GLOBAL SOLUTIONS LIMITED, Dublin 4 (IE)

(21) Appl. No.: 18/393,864

(22) Filed: Dec. 22, 2023

(30) Foreign Application Priority Data
Dec. 28, 2022 (IN) 202211076125

(51) Int. Cl. G06Q 10/0631

(52) U.S. Cl. CPC G06Q 10/0631

(57) ABSTRACT

An Artificial Intelligence (AI)-based data product provisioning wherein a data product responsive to an informational requirement of a user query is identified or automatically built is disclosed. An enhanced user query generated from the received user query is used to search a plurality of data sources. Mapped search results are obtained and features of the mapped search results are used to determine if the responsive data product exists within the plurality of data sources. Else, a logical data product (LDP) including data entities required to build a responsive physical data product (PDP) is generated. The code to build the PDP is created from the LDP and executed on a target platform where the PDP is built. One or more of the PDP and an output of the PDP can be provided to the user as a reply to the user query.

### PRIORITY

The present application claims priority under 35 U.S.C. 119(a)-(d) to the Indian Provisional Patent Application Serial No. 202211076125, having a filing date of Dec. 28, 2022, the disclosure of which is hereby incorporated by reference in its entirety.

### BACKGROUND

Search engines enable users to locate relevant information from large quantities of data e.g., the internet resources such as web pages, news groups, programs, images, etc. Users can search for any information by passing a query including keywords or phrases. The search engine attempts to provide relevant information to the user by employing the user's query. Search engines usually include a mechanism for traversing the web to gather information (e.g., a web crawler). However, applications also include search interfaces so that users may request and obtain desired information. For example, search interfaces are included with different types of applications such as databases, documents, collections of files, unstructured data stores, etc. These search interfaces facilitate user searches thereby addressing their informational needs.

### BRIEF DESCRIPTION OF DRAWINGS

Features of the present disclosure are illustrated by way of examples shown in the following figures. In the following figures, like numerals indicate like elements, in which:

FIG. 1 shows a block diagram of an Artificial Intelligence (AI)-based data product provisioning apparatus in accordance with the examples disclosed herein.

FIG. 2 shows a block diagram of a user query analyzer in accordance with the examples disclosed herein.

FIG. 3 shows a block diagram of a data product identifier in accordance with some examples disclosed herein.

FIG. 4 shows a block diagram of a data product builder in accordance with some examples.

FIG. 5 shows a flowchart of a method of obtaining a reply to a user query from a responsive data product in accordance with the examples disclosed herein.

FIG. 6 shows a flow diagram for retrieving results for the user query in accordance with the examples disclosed herein.

FIG. 7 shows the flow diagram for mapping the data entities/data products across the different data sources in accordance with the examples disclosed herein.

FIG. 8 shows the pre-processing of data and the creation of a training dataset in accordance with the examples disclosed herein.

FIG. 9 shows a flow diagram for sentiment analysis in accordance with the examples disclosed herein.

FIG. 10 shows a flowchart for the process implemented by a Machine Learning (ML) recommendation engine in accordance with the examples disclosed herein.

FIG. 11 shows a flowchart of a method of determining if a responsive data product is available in accordance with some examples.

FIG. 12 shows a flow chart of a method of building a physical data product (PDP) in accordance with some examples.

FIG. 13 shows a flowchart for a method of automatically generating the code for building one or more tables in accordance with some examples.

FIG. 14 shows a flow chart for generating a table as a data product in accordance with the examples disclosed herein.

FIG. 15 shows a block diagram of the feature engineering implemented by a feature analyzer in accordance with the examples disclosed herein.

FIG. 16 shows a Logical Data Product (LDP) including a knowledge graph in accordance with some examples.

FIGS. 17A-C illustrate a use case of a PDP being generated from a user query in accordance with some examples.

FIG. 18 illustrates a computer system that may be used to implement the AI-based data product provisioning apparatus in accordance with the examples disclosed herein.

### DETAILED DESCRIPTION

For simplicity and illustrative purposes, the present disclosure is described by referring to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” mean including but not limited to. The term “based on” means based at least in part on.

An AI-based data product provisioning system with associated apparatus and methods is disclosed herein. The data product provisioning system receives a user query, identifies a data product responsive to the user query, and provides an output of the responsive data product as a reply to the user query. In an example, the user query can be enhanced to generate an enhanced search query which is used to search an enterprise data corpus. If a responsive data product is located, data to frame a reply to the user query is obtained as an output from the data product. If the responsive data product cannot be located within the enterprise data corpus, then the responsive data product is generated by the apparatus, and the output of the generated, responsive data product can be provided as a reply to the user query.

Any data structure including a digital product or feature stored in a non-transitory, machine-readable medium can be considered a “data product” or particularly, a “physical data product” (i.e., PDP) if the data structure uses data as input to directly or indirectly facilitate a goal for a defined set of users. Examples of digital products or data products can include but are not limited to, curated data sets, analytical models, various dashboards, etc. Data products may encompass without limitation, a customer 360 dashboard, a customer churn prediction model, or just a simple structured or an unstructured data set. Data products are discoverable, trustworthy, secure, self-describing and addressable, interoperable, accessible, governed, and purposeful. A data entity is any digital entity that is either the data itself or the metadata, relationships, transformation logic, or process-related information about the data. A conceptual data product (or CDP) is a representation or listing of the business requirements (e.g., a requirements document for the end goal or purpose) of the data product. This is converted to a technical blueprint of the data product to be able to build it physically. This technical blueprint can be referred to as the logical data product (or LDP). LDPs include various data entities such as but not limited to, data assets (e.g. tables) that are combined to build a product, transformation logic, technical metadata (e.g., schema), business metadata (e.g., business terms, domain tags, etc.), governance assets (e.g., rules and policies), accessibility (e.g., access control list), Service Level Agreements (SLAs) (e.g., completeness, uptime, remediation), Key Process Indicators (KPIs) e.g., time since last update, null-count, recovery tune, skewness, etc. and entity relationships between data assets (e.g., foreign keys) for joining conditions. The term ‘data product’ is generally applicable herein to a ‘physical data product’ (PDP) unless specified otherwise.

The LDP is converted to a prototype and the prototype may be verified. If needed, LDP may be re-designed based on the verification and then rebuilt iteratively till the right version is achieved. Then the prototype is used to build the PDP i.e., the data structure stored in a non-transitory, processor-readable storage medium to test it. After the build, the PDP is validated against the business requirements (CDP) and the technical blueprint (LDP). The PDP is published to the enterprise data product catalog for discovery and access by users. Every PDP is continuously monitored and maintained as required. In some cases, it may even be evolved, archived, or decommissioned as required.

Enterprise data implementations include a vast volume of data entities. It can be difficult and time-consuming to find the right data entities. Therefore, there is a need for context-aware recommendations for the best fit and trustworthy data products that provide accurate information to user queries. Furthermore, if such data products cannot be identified, the enterprise data corpora may store data entities that can be used to build data products quickly thereby addressing users' informational needs. Currently, enterprise search and manual processes are used for identifying the best fit and trustworthy data entities. However, existing enterprise search methodologies fail to provide the required recommendations as they fail to provide different types of data entities required for building data products. Enterprise search tools for data entities are not context-aware and rely heavily on humans for contextual validations. As a result, accurate, fast searches are not enabled. For example, identifying the right data entities to build a data product via a search may take 24-48 hours for each data product which results in a lengthy cycle time. Furthermore, the search coverage is not 100% as some relevant entities may be missed out. Comprehensive search requires multiple iterations (typically 4 to 12) between the build and re-design of LDP. Long cycle time and multiple iterations lead to excess compute consumption and multiplied costs. Even with the use of Natural Language Processing (NLP), accuracy remains poor for short-text queries. Search interfaces are not able to provide relevant recommendations to make the process more effective and efficient. A lengthy query with multiple terms may need to be provided by the user for the search engine to derive the context. In search engines based on topic modeling, the number of topics is predetermined and such search engines can only compare texts of similar length. Another topic modeling implementation can include N-gram techniques. In this case, monograms (single words) aren't specific enough to offer any value. Monograms are rarely used for phrase extraction and context. Instead, they offer other values as entities and themes. N-grams become too noisy, especially for short queries.

The aforementioned difficulties can lead to negative consequences such as incomplete LDP definitions, difficulty in enabling self-service for the users and domain experts, lost opportunities, increased risk, timeline expansions, and high operational costs. The AI-based data product provisioning system disclosed herein enables an enhanced, context-aware text search for data entities and recommends context-aware, best-fit, and trustworthy data entities so that LDPs may be created and managed at scale. Furthermore, the mere identification of data entities to build the data product is insufficient to address the end users' needs. The disclosed AI-based data product provisioning apparatus and methodologies not only enable searches for the responsive data product but also enable building the data product automatically, on the fly, if no responsive data product can be found to provide a reply to the user query.

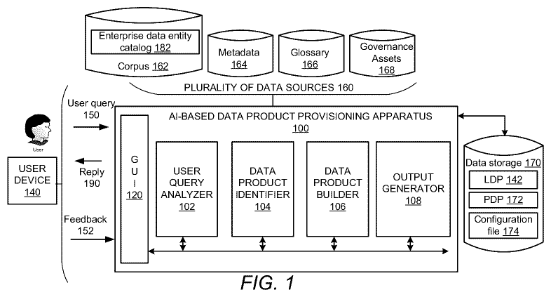

FIG. 1 shows a block diagram of the AI-based data product provisioning apparatus 100 in accordance with the examples disclosed herein. A user may issue a user query 150 in a natural language (via text, voice, or other input modalities), to the apparatus 100 regarding certain requirements or requesting certain information. For example, the user query 150 can pertain to the loss of customers. Accordingly, data assets including data product(s) and/or data entities related to customer churn-specific data and customer domain data may be identified. If no data product can be identified, a corresponding PDP is built from the data entities. Depending on the type of PDP, either the PDP may be provided as the reply 190 or the information requested by the user query 150 may be provided by the apparatus 100 as the reply 190. The apparatus 100 is communicatively coupled to a plurality of data sources 160 that store the various data entities or data products. The plurality of data sources 160 may include but are not limited to an enterprise data corpus 162 including an enterprise data entity catalog 182, metadata 164 and glossary 166, and governance assets 168. The apparatus 100 may include or may be communicatively coupled to a non-transitory, processor-readable storage medium 170 that may store processor-readable or machine-readable instructions or programming code modules of the apparatus 100.

The data product provisioning apparatus 100 includes a user query analyzer 102, a data product identifier 104, a data product builder 106, and an output generator 108. The user query 150 can include a business requirements document or a CDP. The user query 150 is initially processed by the user query analyzer 102 using, for example, NLP techniques to identify other search queries that would retrieve the same information targeted by the user query 150. Accordingly, the different forms of the user query 150 identified by the user query analyzer 102, are used to retrieve the results or data entities from the plurality of data sources 160 by the apparatus 100. In an example, the user query analyzer 102 may implement keyword extraction techniques such as but not limited to, Rake, Yake, Key Bidirectional Encoder Representations from Transformers (KeyBERT), etc. to extract context-based keywords. An enhanced search query can be generated by combining context-based keywords.

The data product identifier 104 uses the enhanced search query to identify if any data products exist within the enterprise data corpus 162 that are responsive to the informational requirements conveyed in the user query 150. The enhanced search query can be used to search the enterprise data entity catalog 182 which includes a listing of data assets such as data products and data entities in the enterprise data corpus 162. If a data product that is responsive to the user query 150 is identified, then the information regarding the data product responsive to the user query 122 is transmitted to the output generator 108 which may further generate the requested information and provide a reply 190 to the user query 150 via the output interface 120 e.g., a Graphical User Interface (GUI). In case the responsive data product includes a machine learning (ML) model, one of a trained ML model or an untrained ML model may be identified by the data product identifier 104 to be output to the user. If a trained ML model is identified, the output generator 108 may provide the input from the enhanced search query 122 to the ML model. The output from the trained ML model can be provided as the reply 190. If an un-trained ML model is identified, the output generator 108 can output the un-trained ML model as the reply 190. The user can train the ML model and obtain the desired information from the trained ML model. If the PDP responsive to the user query 150 cannot be identified from the enterprise data entity catalog 182, the data product identifier 104 identifies a type of the PDP to be generated from a plurality of physical data product types such as but not limited to database tables, visualization dashboards, and analytical/ML models. Based on the type of the PDP to be generated, the data product identifier 104 generates the technical blueprint i.e., the LDP 142 that includes data entities required to build the PDP 172. In an example, the LDP 142 can include a knowledge graph with nodes representing the data entities and edges representing connections between the data entities.

The LDP 142 is provided to the data product builder 106 for building the PDP 172 responsive to the user query 150 when a responsive PDP cannot be identified from the enterprise data entity catalog 182 by the data product identifier 104. The data product builder 106 generates a configuration file, e.g., a config file 174 based on the type of PDP to be built. The config file 174 includes at least details of the data entities required to build the PDP 172. To build the PDP 172, the data product builder 106 automatically creates code from the config file 174. The automatically-created code is further executed by the data product builder 106 on a target platform to generate the PDP 172. Again, if the PDP 172 generated is a database table or a visualization dashboard, then information from the database table or the visualization dashboard can be provided as the reply 190. If the PDP 172 is a type of ML model, then the un-trained ML model is provided by the output generator 108 as the reply 190 to the user query 150. The user may train the ML model and obtain the desired information/data from the trained ML model.

It can be appreciated that although details of examples of PDPs to be generated include database tables, visualization dashboards, and analytical models, the apparatus 100 is not so constrained. Other types of PDPs can also be built based on the config files and executable codes generated by the data product builder 106.

Upon receiving the reply 190, the user may accept or reject the output. The user acceptance and/or rejection statistics are provided as feedback to the apparatus 100 for further training. The apparatus 100 may include user-facing GUI 120 or other interfaces for receiving input such as the user query 150 or feedback 152 and for providing the reply 190 such as database tables or visualization dashboards.

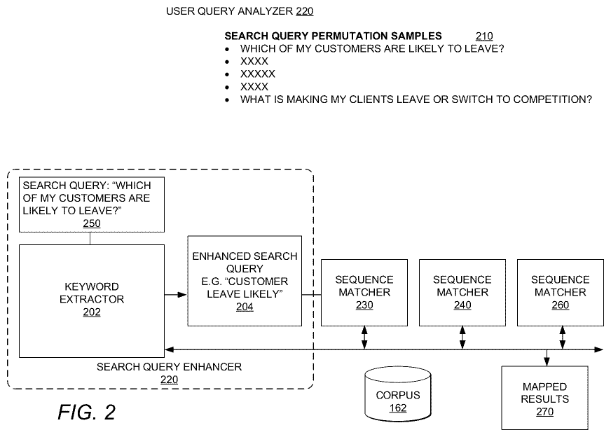

FIG. 2 shows a block diagram of the user query analyzer 102 in accordance with the examples disclosed herein. The user query analyzer 102 includes a search query enhancer 220, a sequence matcher 230, a similarity calculator 240, and a results mapper 260. The user query 150 may include a search query 250, “Which of my customers are likely to leave?” This is a direct question that provides for the context to be derived directly from the query text. Other variations or forms of the same request are shown at 210. These variations may include but are not limited to “Which of my customers are likely to leave?”, “Which customers are we losing to the competition?”, “Why are my customers moving to the competition?”, “Are my customers moving to the competition?”, “Are my clients not engaged with my organization anymore?”, “Are my consumers displaying brand loyalty?”, “How can I minimize customer attrition?”, “What problems can I solve to retain my customers?”, and “What is making my clients leave or switch to competition?” One of the variations, “Why are my customers moving to competition?” is rather complex and does not lend itself to context extraction using simple NLP techniques such as cosine similarity. Hence, the various forms of the search query 250 may be mapped to a single concept “Customer churn”. In order to enable context extraction from the various forms of the search query, i.e., search query permutations 210, the search query enhancer 220 implements KeyBERT which is a keyword extractor 202. It is a pre-trained BERT (Bidirectional Encoder Representations from Transformers) based model. It is generated using unsupervised training. In an example, the keyword extractor 202 can implement a distilbert-base-nli-mean-tokens, which is a sentence-transformers model that maps sentences and paragraphs to a 768-dimensional dense vector space and can be used for tasks like clustering or semantic search. The keyword extractor 202 extracts keywords based on the context. For the example search query 250, the keyword extractor 202 may extract 3 keywords such as “customer, leave, likely” as three monograms based on an N-gram parameter provided to the KeyBERT model along with the example search query 250. In the implementation of the keyword extractor 202, monograms help in reducing noise.

The search query enhancer 220 concatenates the extracted keywords to generate an enhanced search query 204 including only important contextual keywords. This is useful in accurately obtaining results from the corpus 162. The enhanced search query 204 and the various permutations of the search query 210 can be used by the sequence matcher 230 and the similarity calculator 240 to identify the closest matches to the enhanced search query 204 from the corpus 162. The sequence matcher 230 counts the number of matching characters. Hence, it is used for detecting variations in spelling, or typos while the similarity calculator 240 processes semantics. In an example, a similarity technique such as a cosine similarity can be employed by the similarity calculator 240 to match the enhanced search query 204 and the search query permutations 210 to the contents of the corpus 162. The sequence matcher 230 and the similarity calculator 240 apply corresponding thresholds and output respective matches that pass the corresponding thresholds. Using the sequence matcher 230 and the similarity calculator 240 enables obtaining a better match and caters to a combination of both semantic similarity (meaning) as well character similarity (spelling).

The results mapper 260 generates the mapped results 270 by mapping, for example, the same data which may possess different formats in different databases of the corpus 162, the metadata 164, the glossary 166, or the governance assets 168. The mapped results 270 may include one or more of data products and data entities. In an example, the enhanced search query 204 may enable retrieving customer churn-specific industry-standard data and customer domain data product(s) and/or data entities from the corpus 162 that matches not only with the terms ‘customer’, ‘churn’ but may also match synonymous terms such as ‘consumer’, ‘attrition’. Hence, the AI-based data product provisioning apparatus 100 disclosed herein provides an enhancement approach to create a multi-word short phrase using the top mono grams thus providing improved accuracy.

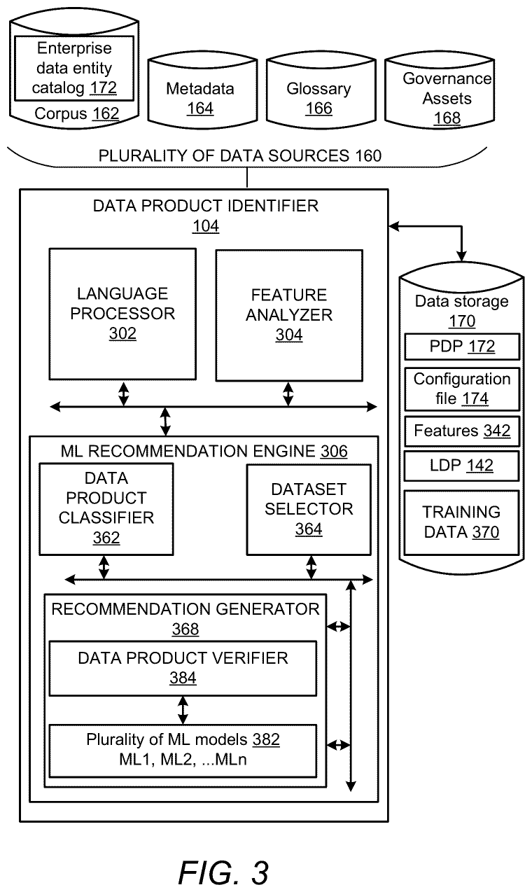

FIG. 3 shows a block diagram of the data product identifier 104 in accordance with some examples disclosed herein. The data product identifier 104 includes a language processor 302, a feature analyzer 304, and an ML recommendation engine 306. The language processor 302 can use NLP techniques to implement a tag-based search of the mapped results 270 to identify an existing data product that is responsive to the user query 150 or to identify data entities from which the PDP 172 responsive to the user query 150 can be built. In an example, various domains from the enterprise data corpus 162 may be represented as tags. The language processor 302 can also extract entity relationships between the data entities in the mapped results 270, based for example, on primary key and foreign key references. The language processor 302 may also derive data product relationships such as composition, aggregation, and association.

The language processor 302 provides its inputs to the feature analyzer 304 for extracting various features not only from the corpus 162 and the governance assets 168 but also from the metadata 164, and the glossary 166 associated therewith. Various features 342 associated with the mapped results 270 are extracted such as but not limited to asset type, entity relationships, user requirement context such as data product and attribute descriptions, recency, ratings, data veracity metrics (data quality), past user acceptance/rejection, sensitivity, asset type, entity relationships, etc. The feature analyzer 304 may include automatic feature engineering tools for feature engineering functions such as dimensionality reduction, feature combination, feature aggregation, and feature transformation.

The ML recommendation engine 306 includes a data product classifier 362, a dataset selector 364, a data product verifier 366, and a recommendation generator 368. The data product classifier 362 may be a supervised, semi-supervised, or unsupervised classifier that uses the features 342 input from the feature analyzer 304 for classifying the mapped results 270 into various types of data products and data entities. The mapped results 270 can thus be classified into different types/categories of data products and data entities. The set of classified results is provided to the dataset selector 364 which may select a given dataset of data product(s) and/or data entities based on the confidence values output by the data product classifier 362.

The dataset selector 364 can also include another supervised, semi-supervised, or unsupervised classification model that employs features such as data rating, data veracity matrix, data quality, past user acceptance/rejections, sensitivity, entity relationships, etc. to classify datasets including the mapped results 270 as qualified or not qualified for identifying and/or building a data product. From the datasets selected by the dataset selector 364, the data product verifier 384 included in the recommendation generator 368 verifies if one or more data products that match the informational needs of the user query 150 are identified. The data product verifier 384 can employ a plurality of ML models 382 for implementing the data product availability check. In an example, the plurality of ML models 382 e.g., ML1, ML2, . . . MLn, (wherein n is a natural number and n=1, 2, 3 . . . ) may include but are not limited to, logistic regression, random forest, Gradient Boosting Machine (GBM), etc. Each time a search query is received, the ML recommendation engine 306 runs multiple iterations of the plurality of models 382 to select the best-performing ML model for the recommendation, based for example, on the outputted confidence values associated with the classified results. The plurality of ML models 382 can use features such as user role, requirements, context, data sensitivity, ratings, etc., for classifying or identifying the type of data product responsive to the user query 150. The plurality of ML models 382 can be trained on training data 370 including sample user queries and data product classification data. The data product verifier 384 may access existing data product descriptions to identify a need for a new data product. The data product verifier 384 may determine the required attributes from the CDP and may compare such attributes with the field-level descriptions of the data products and data entities in the corpus 162 to identify data products and data entities responsive to the user query 150. By way of illustration and not limitation, a user query for customer churn data such as, “How many customers unsubscribed last month?” may be responded to by a database table, and another user query such as, “How is the customer distribution across the various products?” may be answered via a visualization dashboard. Yet another user query such as, “What is the expected demand for product_1 in the next quarter?” can be answered by an analytical or ML model. Accordingly, each of the plurality of ML models 382 may be trained on labeled training data. The labeled training data can include user queries expressing different informational needs and a set of different types of PDPs, wherein each PDP of the set is marked as responsive to a corresponding user query. Based at least on the corresponding confidence values, the data product verifier 366 can further identify programmatically, via a rule-based process, a data product (if any) that is responsive to the user query 150. If no data product is found to have sufficient confidence (e.g., does not clear the confidence threshold), then data entities with the highest confidence values (e.g., which clear the confidence threshold) can be forwarded to the recommendation generator 368. The recommendation generator 368 receives the output of the data product verifier 366 and may produce the reply 190 to the user query 150. If a data product is identified in the output of the data product verifier 384, then the recommendation generator 368 may forward the identified data product directly to the output generator 108 bypassing the data product builder 106. If no data product is provided by the data product verifier 384, then the recommendation generator 368 generates the LDP 142 from the data entities provided by the data product verifier 384. In an example, the LDP 142 can include a knowledge graph that provides a visualization of other data entity-level relationships across the various data assets. One of the data entities or data assets may include data and metadata assets such as but not limited to data product type, schema, samples, profiling results, veracity, ratings and reviews, owner/steward, Proof of Concept (POC), description, data sensitivity, entity relationships (for joins), domain-specific terms, and policies/rules. The LDP 142 is provided to the data product builder 106 for building a data product which can be used to provide the reply 190.

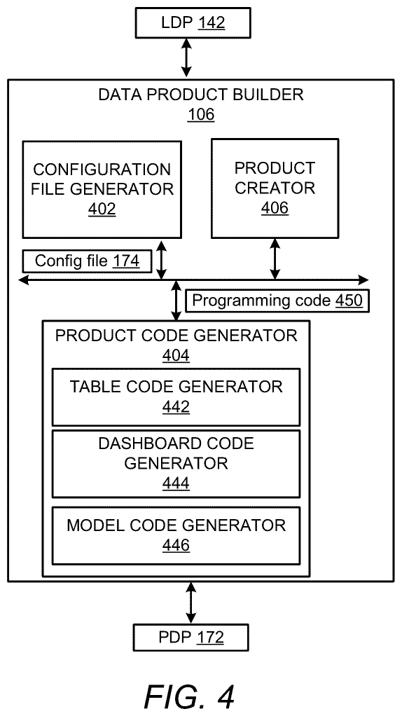

FIG. 4 shows a block diagram of the data product builder 106 in accordance with some examples. The data product builder 106 includes a configuration file generator 402, a product code generator 404, and a product creator 406. As mentioned above, the LDP 142 including one or more of the data product types, the data and metadata assets, the entity relationships, domain-specific terms, policies and rules, is input to the data product builder 106. If the data product type in the LDP 142 specifies that an ML model is to be generated, then the ML model type and its features are also included in the LDP 142. Some implementation details such as programming tools used, etc., are discussed herein for illustration purposes only but it can be appreciated that the functionality described can be achieved via other programming tools, etc. The config file generator 402 can employ scripts e.g., Python® script to read the LDP 142 and extract the details for the config file 174. The config file 174 thus generated can be provided to the product code generator 404 for automatic code generation.

In an example, the product code generator 404 automatically generates the programming code 450 (e.g., Python® code) for creating the PDP 172. The product code generator 404 may include a table code generator 442, a dashboard code generator 444, and a model code generator 446. When the product type to be generated includes structured data such as a table for a relational database, then such requirement is conveyed via the config file 174 which is provided to the table code generator 442. The table code generator 442 can create Data Definition Language (DDL) and Data Manipulation Language (DML) statements (.sql files). The table code generator 442 may implement NLP-based Python® code to read the LDP 142 and generate the Structured Query Language (SQL) based on metadata. The SQL queries are generated based on extracted metadata using NLP to get accurate DML statements with valid join conditions as detailed herein.

When the product type to be generated includes a visualization dashboard, then the config file 174 is provided to the dashboard code generator 444 which automatically generates the Power Business Intelligence Command Line Interface (Power BI® CLI) commands for the dashboard generation. In particular, the dashboard code generator 444 can implement Python® script to call the batch program to generate the Power BI® commands for the reports. The batch program uses the configuration file as the input, which specifies the report attributes, and data aggregation requirements, to generate CLI commands accordingly. When the product type to be generated includes an ML model, then the config file 174 which is provided to the model code generator 446 includes a code framework to be implemented along with the type of ML model to be generated and the feature list. The code framework may include Python® code with source dataset and metadata details, feature list, and call statement for a specific ML model with required parameters. The ML model is recommended based on target value as well as type and volume of data.

On completion of the automatic code generation, the apparatus 100 may optionally provide for validation of the generated code. In an example, Python® code may be included in the product code generator 404 to create an email notification with the generated code files, for review and approval by the data engineer/data scientist. The approval email event is captured for further processing in the workflow. In the case of the automatically generated code for building an ML model, the framework code can be reviewed by the data scientists for manual updates to specify connection details, parameter values, data quality checks as needed, training and test data distributions, etc.

The automatically-generated code from the product code generator 404 is provided to the product creator 406 which automatically executes the received code to create the PDP 172. In an example wherein the PDP 172 can be a table, the product creator 406 can execute the program (e.g., Python® code) to connect to a relational database and execute the multiple .sql files in a sequence on the target platforms e.g., target Relational Database Management System (RDBMS) databases. In an example, the code execution status is captured and saved for a data engineer to review, troubleshoot, and debug. Similarly, in the case of dashboard generation, the product creator 406 can execute a programming script (e.g., Python® script) to call the batch script that connects to a dashboard tool such as Power BI® and execute the application commands i.e., the CLI commands on the target platform (e.g., Power BI®) to build the visualization dashboard. The automatically built visualization dashboard in turn generates the reports which constitute the reply 190 to the user query 150.

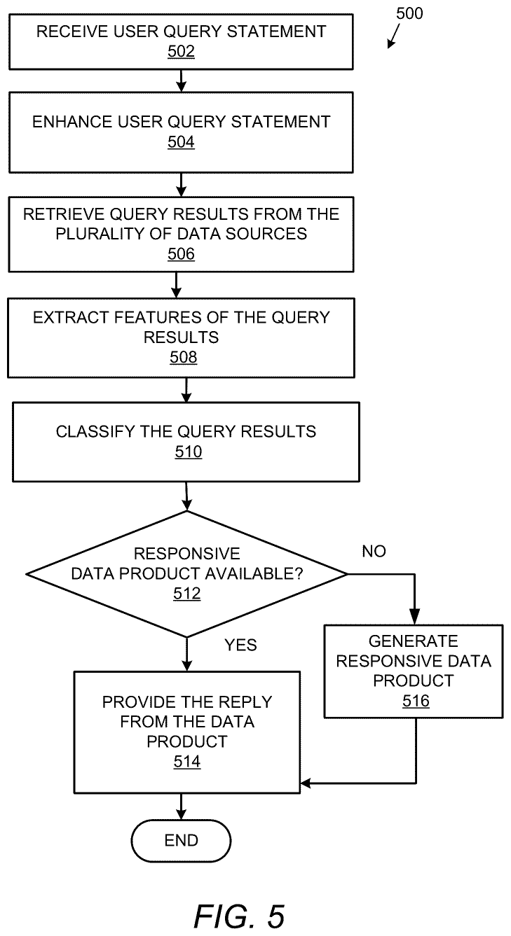

FIG. 5 shows a flowchart 500 of a method of provisioning for a data product responsive to the user query 150 in accordance with the examples disclosed herein. The method begins at 502 wherein the user query 150 is received via, for example, GUI 120. The user query 150 may include a request for information that may be answered by a data product. Accordingly, the user query 150 represents a CDP. At 504, an enhanced user query is generated by identifying keywords and their associated synonyms and alternate queries requesting similar information. In an example, the request JavaScript Object Notation (JSON) of the user query 150 can be parsed to extract query text and metadata. The enhanced user query 204 is employed at 506 to retrieve mapped search results 270 from the plurality of data sources 160. The mapped search results 270 may include one or more of data products and data entities that constitute the data products such as tables columns, join keys, etc., and corresponding metadata such as table aliases, etc. Natural language processing can be used to implement tag-based search on the mapped search results 270 from the plurality of databases 160 so that relevant information regarding the data asset type, entity relationships, data products, and their relationships, etc., is retrieved. At 508, features 342 of the mapped search results 270 are extracted and classified at 510. From amongst the classified results, it is determined at 512, if a data product responsive to the user query 150 is available within the plurality of data sources 160. If it is determined at 512 that a data product responsive to the user query 150 is available within one or more of the plurality of data sources 160, then the method moves to 514 wherein the data product is accessed and the reply 190 to the user query 150 is provided by the data product. If it is determined at 512 that a data product responsive to the user query 150 is not available within the plurality of data sources 160, the method moves to 516 wherein a data product responsive to the user query 150 is generated and the reply 190 to the user query 150 may be provided by generated data product as shown at 514. Alternately, in case the generated data product includes an ML model, then the data product itself, i.e., the generated ML model may be provided as the reply 190 to the user query 150. In an example, the ML model generated by the apparatus 100 is untrained. The user receiving the ML model as the reply 190 may need to train and test the ML model before obtaining the information requested in the user query 150.

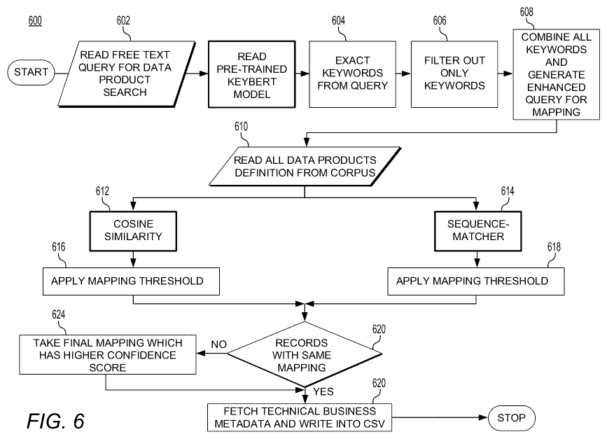

FIG. 6 shows the overall flow diagram 600 for retrieving results for the user query 150 in accordance with the examples disclosed herein. A pre-trained KeyBERT model can be used to extract 604 keywords from the user query 150. The extracted keywords can be filtered 606 to select the monograms that are combined 608 to generate an enhanced query for mapping. The enhanced query can be used to read 610 the data product/data entity definitions from the corpus 162 or the enterprise data entity catalog 182. The results retrieved from the corpus 162 are processed for similarity 612 and sequence matching 614. The corresponding thresholds are applied at 616 and 618, and it is determined at 620 if the mappings of the keywords to the data entities in the corpus 162 that cleared the threshold for the cosine similarity are the same as those that cleared the threshold for the sequence matching. If yes, the mapped results 270 are obtained 622 as the final mapped metadata. If the results do not have the same mappings, then the mappings of the keywords to the data entities/data products with the higher confidence score from the cosine similarity or the sequence matcher are provided 624. The mappings help in identifying data entities/data products that are essentially the same but may be encoded in different forms. For example, an address field may be encoded as “Address” in one data entity whereas it may be encoded as “Add” in another data entity and a user's search on the apparatus 100 using the enhanced search query will retrieve both the results.

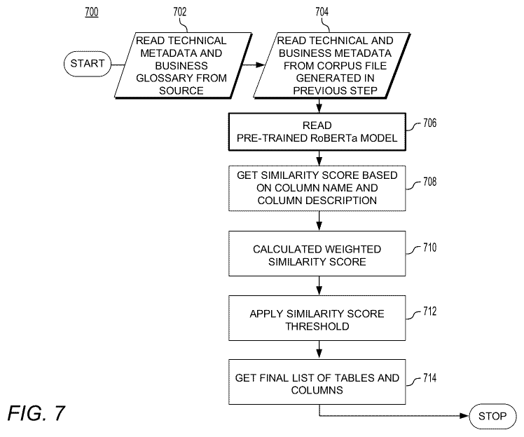

FIG. 7 shows the flow diagram 700 for NLP metadata mapping of the data entities/data products across the different data sources of the plurality of data sources 160 in accordance with the examples disclosed herein. At 702, the technical metadata and the business glossary are read from one or more of the plurality of data sources 160 using the enhanced search query 204 and permutations thereof. At 704, the technical and business or domain-specific metadata is accessed also from corpus 162. In an example, the field names may be provided as a technical description of the field. The metadata read at steps 702 and 704 is provided 706 as input to a Robustly Optimized BERT-Pretraining Approach (ROBERTa) model to obtain mappings of the data fields processed for mapping to the search query. e.g., customer churn. The similarity score is obtained at 708 based on the column name and column description. The weighted similarity score is calculated at 710 and the similarity score threshold is applied at 712. The metadata mappings that clear the similarity threshold at 712 are obtained at 714 as the final list of the data entities including tables, views, etc., and selected, relevant columns/fields of such data entities.

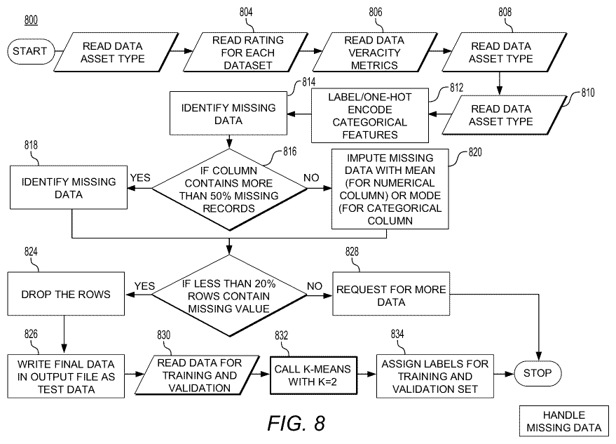

FIG. 8 shows the pre-processing of data and the creation of a training dataset for training the plurality of ML models 382 in accordance with the examples disclosed herein. Data for various model features including the asset data type is read at 802 along with the rating for each dataset 804, the data veracity metrics 806, recency in terms of usage 808, and past user acceptance/rejection details 810 are obtained. The categorical features are labeled/encoded at 812 and the missing data is identified at 814. It is determined at 816 if a column contains more than 80% missing records, if yes, it is dropped at 818 from processing else the missing data is imputed at 820 with the mean/mode. It is further determined at 822 if less than 20% of the rows contain missing values. If it is determined at 822 that more than 20% of the rows contain missing values, further data is requested at 828 and the method terminates on the end block. If it is determined 822 that less than 20% of the rows contain missing values, then the rows are dropped 824 and the final data is written 826 in the output file as test data. The data is read 830 for training and validation. The K-means methodology is implemented at 832 and the labels are assigned at 834 for the training and validation sets.

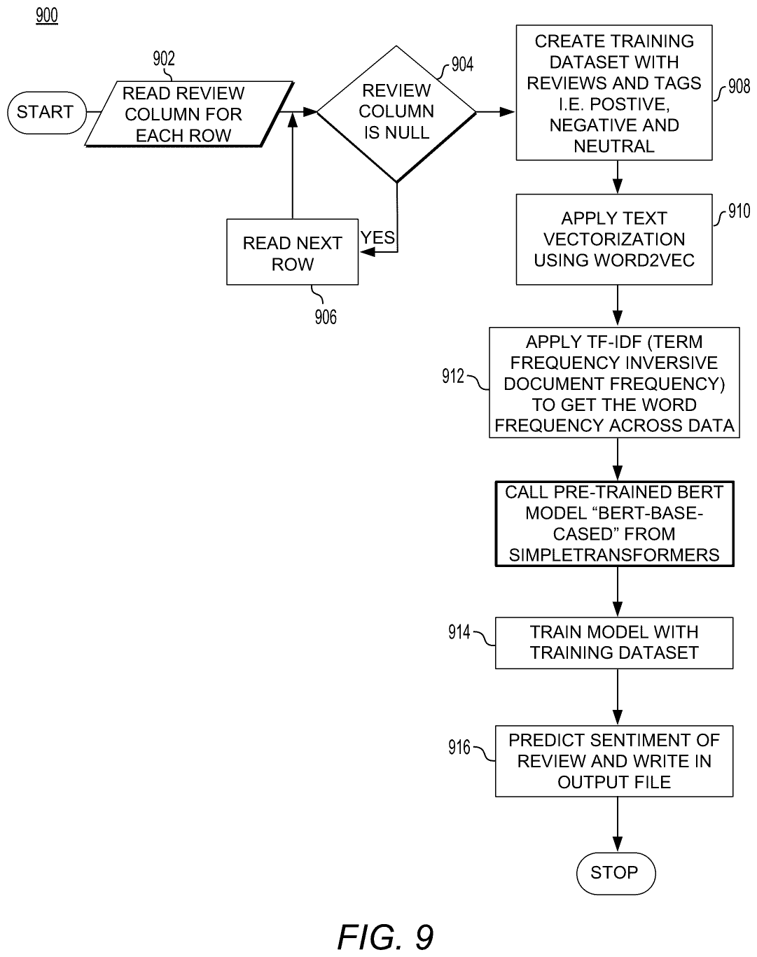

FIG. 9 shows a flow diagram 900 for sentiment analysis in accordance with the examples disclosed herein. The method begins at 902 wherein the review column for each row is accessed. At 904 is determined if the review column is null. If yes, the method moves to the next row at 906 so that rows with no review columns are discarded from further processing. At 908, training data is created with the reviews tagged as positive, negative, or neutral. At 910 the text vectorization using, for example, Word2Vec and tf-idf is applied at 912 to obtain the word frequency across the data. A pre-trained BERT model is trained 914 with the training data. The sentiment for a given data entity or data product which may include a table, a row, a column, a view, a visualization dashboard, or a ML model, etc., is predicted at 916 and written to the output file.

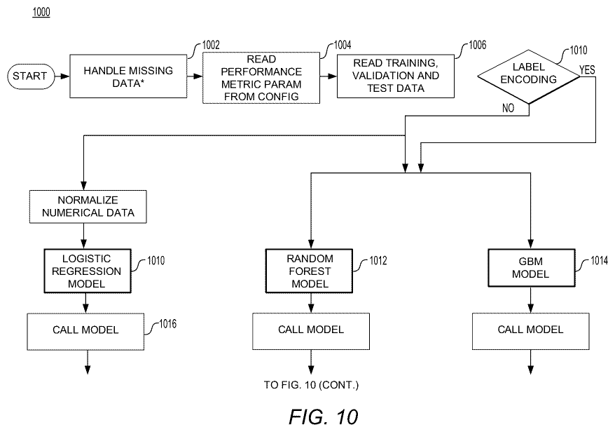

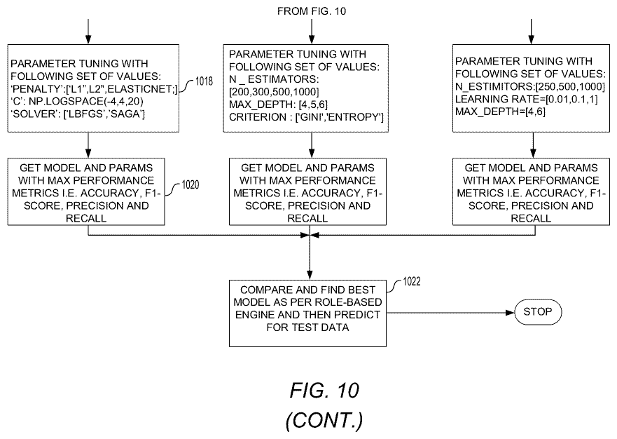

FIG. 10 shows a flowchart 1000 for the process implemented by the ML recommendation engine 306 for identifying a best-performing ML model from the plurality of ML models 382 in accordance with the examples disclosed herein. As different kinds of data entities and/or data products are to be identified by the apparatus 100 and since different performance metrics are implemented based on the type of data entity/data product and use case, a plurality of ML models 382 based on ML algorithms of different types can be implemented by the ML recommendation engine 306. In an example, a configuration file can include details regarding the type of performance metrics to be used for a given use case. Accordingly, at 1002 missing data is handled and at 1004, the performance metrics are obtained from the config file and the training and testing data is accessed at 1006. At 1010 it is determined if a column is encoded and a model e.g., a tree-based model may be selected based on the encoding. If there is no label encoding involved, then any of the plurality of models 382 such as a logistic regression model 1010, random forest model 1012, and Gradient Boosting Machine (GBM) 1014 model may be used. At 1016, each of the models 1010, 1012, and 1014 are called and hyperparameter tuning is executed at 1018. Different model/parameter combinations can be created and tested for each of the plurality of ML models 382 and the model-parameter combination with the best performance metrics, is selected at 1020 for each of the plurality of models 362. In an example, performance metrics such as but not limited to, accuracy, F1-score, precision, recall, etc., are used for the selection of the model-parameter combination for each of the plurality of models 382. At 1022, the model with the highest performing metrics is selected from the model-parameter combinations obtained at 1020 as per a rule-based procedure that can be implemented programmatically. The rules can check for scenarios such as but are not limited to i) When the target class is well balanced then accuracy is a good metric ii) In the case where precision and recall are equally important then F1-score is used. It works well with imbalanced class. iii) Recall is a useful metric in cases where False Negative is of higher concern than False Positive, and iv) Precision is useful in the cases where False Positive is a higher concern than False Negatives. The selected model can predict the recommendations for one of the data products (if any are responsive) or the data entities that are suitable for generating a data product responsive to the user query 150. The data entity recommendations for building a data product may be generated by appending metadata such as domain-specific terms, asset names, column names, and rules/policies. Each of the search query enhancement, feature processing, model training, and selection may occur each time a user query is received.

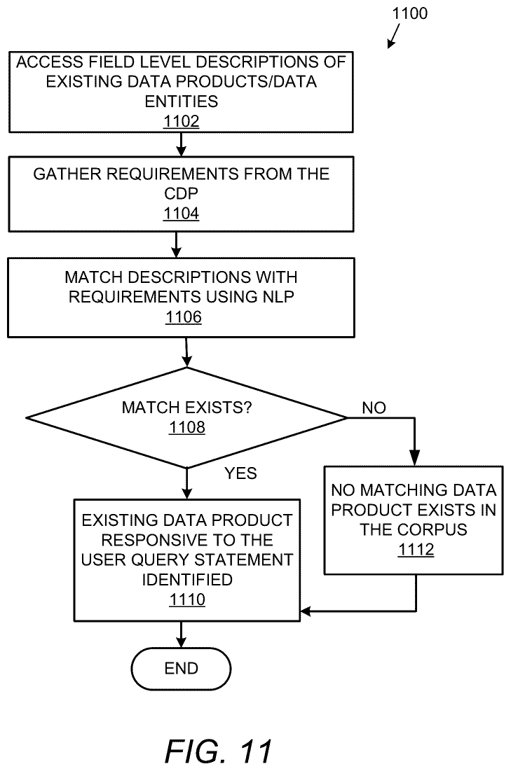

FIG. 11 shows a flowchart of a method of determining if a responsive data product is available in accordance with some examples. The best-performing ML model from the plurality of ML models 382 may be used to determine the existence of a responsive data product. At 1102 the field-level descriptions of the existing data products are accessed. The field-level descriptions can be accessed from the metadata 164 and or the enterprise data entity catalog 182. At 1104 the required attributes for the responsive data product for the user query 150 can be gathered from the CDP. At 1106, NLP-based matching techniques are applied to match the field-level descriptions of the existing data products with the requirements gathered from the CDP. It is determined at 1108 by the best-performing ML model if a match exists between the field-level descriptions of the existing data products and the requirements expressed in the user query 150 and gathered from the CDP. If yes, it is determined at 1110 that an existing data product has been identified as responsive to the user query. If no match could be identified at 1108, it is determined at 1112 that no matching data product responsive to the user query 150 currently exists in the corpus 162.

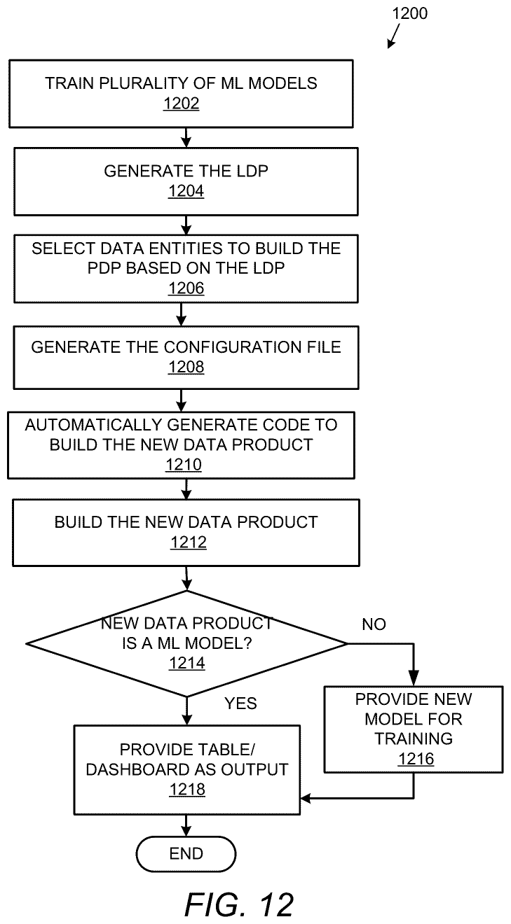

FIG. 12 shows a flow chart 1200 of a method of building a physical data product in accordance with some examples. The method begins at 1202 wherein the plurality of ML models 382 are trained to identify a type of data product that is to be generated in response to the user query 150. The training data 370 may be labeled training data and can include sample user queries and classifications of the corresponding data products that are identified as being responsive to the sample user queries. At 1204, the LDP 142 including the various data entities required to build the data product and the corresponding relationships between the various data entities is generated by the best-performing ML model of the plurality of ML models 382 By way of illustration and not limitation, the data entities may include data and metadata assets such as schema, samples, profiling results, veracity, ratings and reviews, descriptions, data sensitivities, etc. In an example, the LDP 142 can be output as a knowledge graph showing the various data entities as nodes and the relationships between the various data entities as edges of the knowledge graph. The data entities to build the PDP are selected at 1206 using the information from the LDP 142. At 1208, the configuration file 174 is generated from the LDP 142 and the details of the configuration file 174 can be extracted from the LDP 142 programmatically using, for example, scripting tools such as Python® script. The configuration file 174 is accessed at 1210 to automatically generate the code to build the new data product. Different types of code or programming commands can be generated for different types of data products. For example, if a table is being generated then the programming commands can include .sql files with DML and DDL statements. If a visualization dashboard is to be built, then the programming code may include commands for the corresponding application e.g., Power BI® that will build the visualization dashboard. In case an ML model is being built then programming code such as Python® code framework with the source data set and metadata details such as feature list call statements for a specific model with the required parameters are automatically generated at 1210. In an example, the automatically generated code may be optionally validated by a data scientist prior to building the PDP. At 1212 the new data product is built by executing the code that was automatically generated at 1210. It may be determined if the type of new data product generated is an ML model. If yes, the method proceeds to 1216 wherein the new ML model is provided to the user for training before the user can get the information requested in the user query 150. If it is determined at 1214 that the new data product is one of a table or a visualization dashboard then the information from the table or the visualization dashboard can be provided to the user as the reply 190 which is completely responsive to the user query 150.

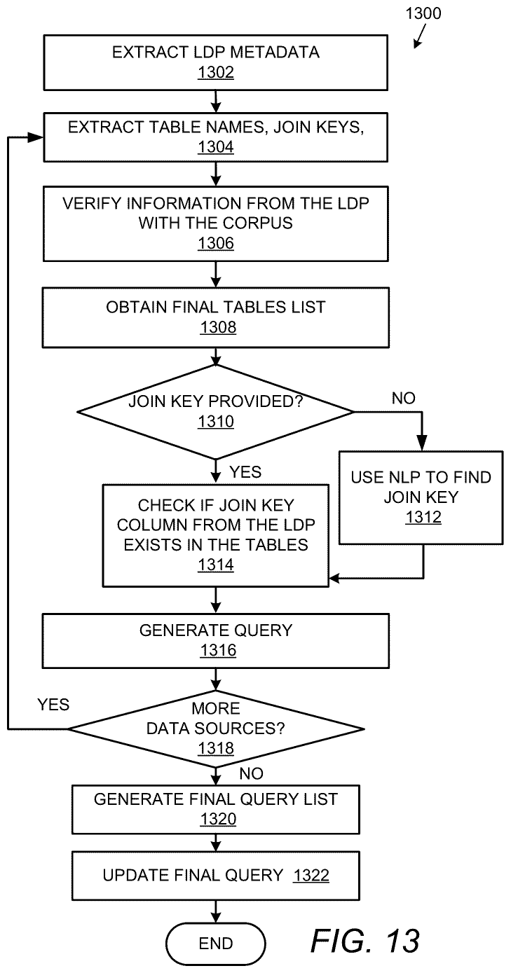

FIG. 13 shows a flowchart 1300 for a method of automatically generating the code for building a data product including one or more tables with data obtained from one or more of the plurality of data sources 160 in accordance with some examples. The method 1300 involves converting the information from the LDP 142 to a PDP by generating SQL statements to extract table data from one or more of the plurality of data sources 160. The method begins at 1302 wherein the LDP metadata is extracted using NLP techniques via tools such as Colibri® Application Programming Interfaces (API). At 1304, the table names, join keys, etc are also extracted. Furthermore, any transformations of table names/column names required between different data sources can also be executed at 1304. At 1306 various checks are run to verify information such as table names and joins etc. from the LDP 142 with the corpus 162. If the tables with specified names cannot be found, then NLP including text mapping approaches can be used for all the table names from the metadata 164 to identify valid table names. At 1308 the final table list is obtained. At 1310, it is determined if a join key is provided between any two tables. If at 1310, it is determined that no join key is provided, then NLP techniques can be used to find a join key between the two tables at 1312. The primary key or columns without any null values are identified from the first table. All the columns of the second table are accessed using the table metadata. A pre-trained ROBERTa model is read and a similarity score based on the column name and column description is obtained between the column from the first table and the columns of the second table. A weighted similarity score is also calculated and compared with a predetermined similarity threshold. The joins are identified on those columns which meet the similarity threshold.

At 1314 it is checked if the join key column provided in the input exists in the metadata 164. If the join key column cannot be identified from the metadata NLP techniques can be used to get a valid column name. The query is generated at 1316. At 1318 it is determined if more data sources exist to be processed for the SQL generation. If yes, the method returns to 1304 else the method proceeds to 1320 to generate the final query list. In an example, the final queries in the list may be validated and any changes upon validation are updated at 1322.

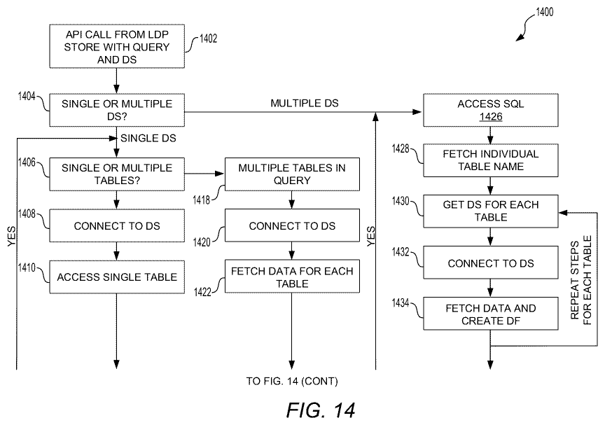

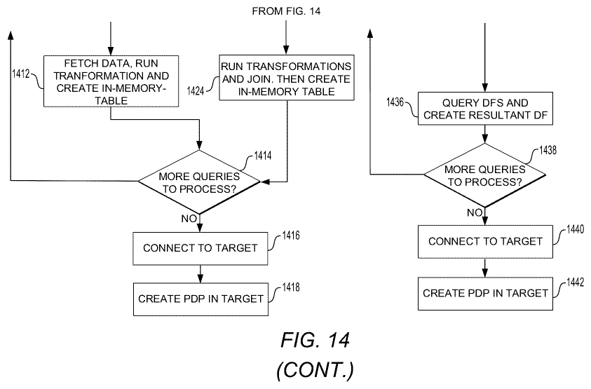

FIG. 14 shows a flow chart 1400 for generating a table as a data product in accordance with the examples disclosed herein. Initially, the SQL statements that were generated are fetched, the target data sources named in the SQL statements are accessed, and the data is pulled from the target data sources. Data thus obtained is curated according to the various join conditions and transformed. The curated data is loaded into the target data product i.e., the target table. The enterprise data entity catalog 182 may then be updated with the information of the newly created target table. Accordingly, at 1402 there can be an API call from the LDP store with the final query that was created and the corresponding data source, at 1404 it is determined if the query involves a single or multiple data sources. If it is determined at 1404 that the query accesses a single data source, the apparatus 100 connects to the data source. It is further determined at 1406 if the query accesses a single table or multiple tables. For the case where the query involves a single table, the single table is accessed at 1410 and the data is fetched from the single table and transformed and an in-memory table (e.g., in the cache or internal memory of the apparatus 100) is created at 1412. It is further determined at 1414 if more queries are to be processed. If yes, the method returns to 1406 to connect to the data source. If it is determined at 1414 that no more queries are to be processed, the method moves to connect to the target platform at 1416 and the final PDP is created in the target platform at 1418.

If it is determined at 1406 that the query involves multiple tables, the multiple-table query is processed at 1418 by connecting to the data source at 1420. The data is fetched for each table at 1422 the transformation and joins are executed and an in-memory table is created at 1424. The method moves to 1414 to determine if more queries are to be processed and the process described above is repeated if further queries are to be processed. If no queries remain to be processed, the method moves to 1416 and continues as described above.

If it is determined at 1404 that multiple data sources are to be accessed, the method moves to 1426 to access the SQL query. The individual table name is fetched at 1428 and the data source is accessed for each table at 1430. The apparatus 100 connects to the data source at 1432 the data is fetched, and a data frame DF is created at 1434. The DFs are queried and a resultant DF is created at 1436. It is determined at 1438 if more queries are to be processed. If yes, the method returns to 1426, else the apparatus 100 connects to the target data source at 1440 the PDP is generated in the target platform at 1442.

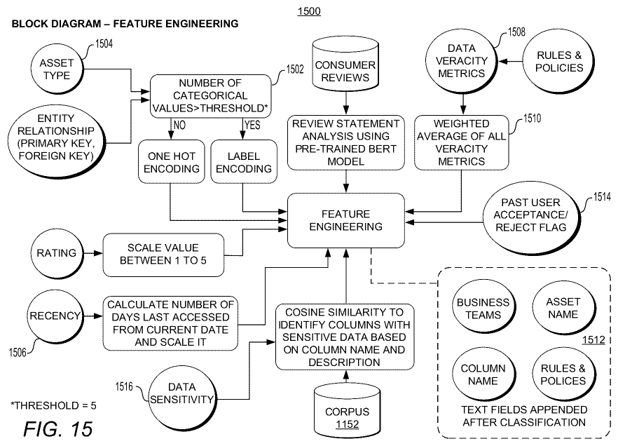

FIG. 15 shows a block diagram 1500 of the feature engineering implemented by the feature analyzer 304 in accordance with the examples disclosed herein. Various features including but not limited to, different encoding techniques, e.g., one hot encoding or label encoding are selected based on the number of categorical values. The feature analyzer 304 can implement automatic feature engineering for many of the features. NLP can be utilized in identifying the name of the feature and the kind of feature engineering applicable. For example, data entity type 1504 is a categorical feature that bears a value that represents or conveys the information associated therewith. In comparison, recency 1506 cannot be obtained directly from the source as a value, etc. Rather, the value for recency has to be derived based on other fields e.g., a date field. The feature engineering implemented by the feature analyzer 304 processes the date fields associated with the different data entities to identify specific date fields that can be used for deriving data recency. The process involves determining from the corpus 162 if it is a last accessed date, then anything of the fields e.g., last updated date or last modified date that maps closely to the ‘last accessed’ date field is what needs to be used for the mapping and an action for calculating the number of days is to be executed. For the ‘rating’ feature, if the rating is between 1-8 then no action may be required, however, higher ratings may need to be scaled for uniformity. For review ratings, sentiment analysis is applied and its output is one hot encoded so that it can be input into the model. Different data types have different veracity metrics 1508. Configurable weights can be applied for different data veracity metrics based on the importance of the particular data and a weighted average 1510 of all the veracity metrics may be obtained. Certain text fields 1512 may not be processed by the feature analyzer 304 but they are nevertheless selected as they are used for identifying the specific data entities to be recommended. Another feature to be processed includes past user acceptance/rejection data which if it is a number, may be used directly, or else it is encoded. Data sensitivity 1516 is another feature that is processed for tagging. The corresponding action implemented may include masking or encoding the sensitive data.

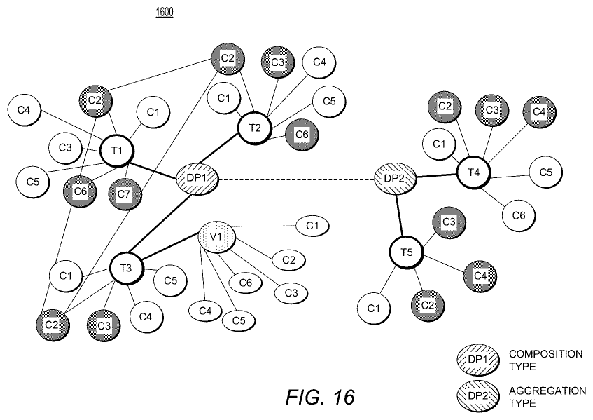

FIG. 16 shows an LDP 1600 including a knowledge graph in accordance with some examples. The relationships between different data entities associated with a data product are represented as edges while the data entities are represented as nodes in the LDP 900 in accordance with examples disclosed. A data product DP1 may be related to another data product DP2. Similarly, other data entities such as tables (represented as T1, T2, . . . ), views (represented as V1), the columns (represented as C1, C2, . . . ) for each table therein, etc., displayed in the visualizations enable the user in understanding the kind of data product being built and, its dependencies. The visualization may enable the user to provide feedback based on the particular model(s) to be updated.

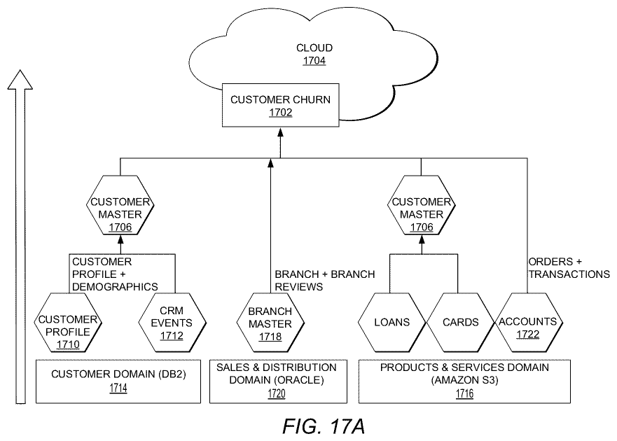

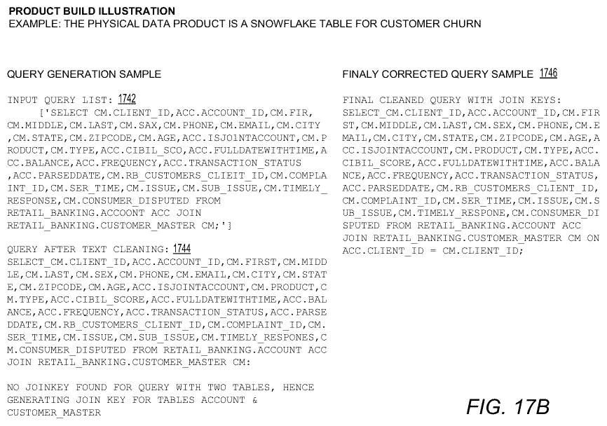

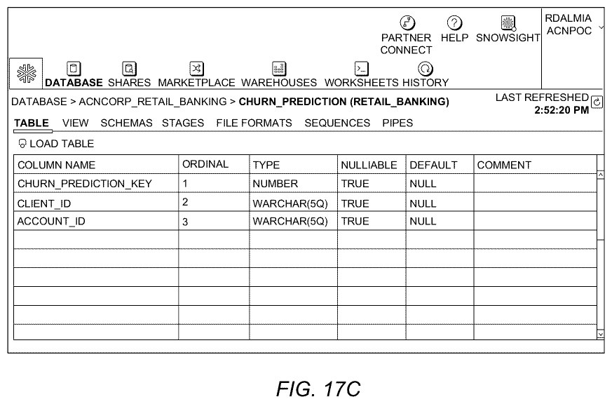

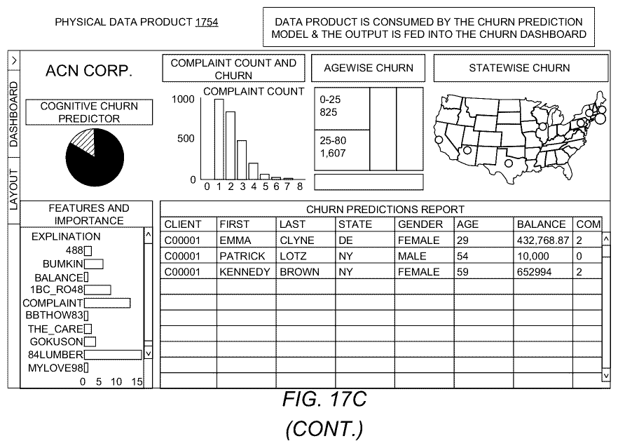

FIGS. 17A-C illustrate a use case of a PDP being generated from a user query in accordance with some examples. It can be appreciated that some applications are named in this example for illustration purposes only and that the methodologies described herein are not limited to these applications and may be implemented in other applications. As shown in FIG. 17A, the PDP built in this use case includes a Customer Churn 1702 table in a cloud target 1704. The Customer Churn 1702 table is built from Customer Master 1706 and Product Master 1708 tables. The Customer Master 1706 table may aggregate customer profile and demographics data 1710 from Customer Relationship Management (CRM) events 1712 which pertain to the customer domain 1714. The Product Master 1708 table can aggregate data regarding loans, cards, orders, and/or transactions from the Accounts 1722 table in the Products and Services domain 1716. Additionally, the Customer Master 1706 and the Product Master 1708 tables may include data from the Branch Master 1718 table from the Sale and Distribution domain 1720. The domains may not all use the same databases. For example, the customer domain 1714 uses Db2®, the sales and distribution domain 1720 uses Oracle® while the products and services domain 1716 may use Amazon S3®. To aggregate data from these various domains, the NLP methodologies disclosed herein are required to identify synonymous entities from one domain to the other. Mapping of primary/foreign keys to derive joins between the different tables across different domains needs to be implemented. Further, data transformations are required so that the data from these various domains and different databases can be presented in the newly created Customer Churn 1702 table in a homogenous format.

FIG. 17B shows query generation for building the Customer Churn 1702 table in accordance with some examples. Input query list 1742 is shown below:

[′SELECT CM.CLIENT_ID, ACC.ACCOUNT_ID, CM.FIR, CM.MIDDLE, CM.LAST, CM.SAX, CM.PHONE, CM.EMAIL, CM.CITY, CM.STATE, CM.ZIPCODE, CM.AGE, ACC.ISJOINTACCOUNT, CM.PRODUCT, CM.TYPE, ACC.CIBIL_SCO, ACC.FULLDATEWITHTIME, ACC.BALANCE, ACC.FREQUENCY, ACC.TRANSACTION_STATUS, ACC.PARSEDDATE, CM.RB_CUSTOMERS_CLIENT_ID, CM.COMPLAINT_ID, CM.SER_TIME, CM.ISSUE, CM.SUB_ISSUE, CM.TIMELY_RESPONSE, CM.CONSUMER_DISPUTED FROM RETAIL_BANKING.ACCOUNT ACC JOIN RETAIL_BANKING.CUSTOMER_MASTER CM;′]

The input query list 1742 shows the different columns selected from two tables, Accounts 1722 (ACC) and Customer Master 1710 (CM). On cleaning up the extraneous characters, Query 1744 shown below is produced.

SELECT CM.CLIENT_ID, ACC.ACCOUNT_ID, CM.FIRST, CM.MIDDLE, CM.LAST, CM.SEX, CM.PHONE, CM.EMAIL, CM.CITY, CM.STATE, CM.ZIPCODE, CM.AGE, ACC.ISJOINTACCOUNT, CM.PRODUCT, CM.TYPE, ACC.CIBIL_SCORE, ACC.FULLDATEWITHTIME, ACC.BALANCE, ACC.FREQUENCY, ACC.TRANSACTION_STATUS, ACC.PARSEDDATE, CM.RB_CUSTOMERS_CLIENT_ID, CM.COMPLAINT_ID, CM.SER_TIME, CM.ISSUE, CM.SUB_ISSUE, CM.TIMELY_RESPONSE, CM.CONSUMER_DISPUTED FROM RETAIL_BANKING.ACCOUNT ACC JOIN RETAIL_BANKING.CUSTOMER_MASTER CM;

However, no join key was found for the Accounts 1722 and Customer Master 1710 tables. A join key is automatically generated between the Accounts 1722 and the Customer Master 1710 tables on the client_id column in the final corrected query sample 1746 shown below:

SELECT CM.CLIENT_ID, ACC.ACCOUNT_ID, CM.FIRST, CM.MIDDLE, CM.LAST, CM.SEX, CM.PHONE, CM.EMAIL, CM.CITY, CM.STATE, CM.ZIPCODE, CM.AGE, ACC.ISJOINTACCOUNT, CM.PRODUCT, CM. TYPE, ACC.CIBIL_SCORE, ACC.FULLDATEWITHTIME, ACC.BALANCE, ACC.FREQUENCY, ACC.TRANSACTION_STATUS, ACC.PARSEDDATE, CM.RB_CUSTOMERS_CLIENT_ID, CM.COMPLAINT_ID, CM.SER_TIME, CM.ISSUE, CM.SUB_ISSUE, CM.TIMELY_RESPONSE, CM.CONSUMER_DISPUTED FROM RETAIL_BANKING.ACCOUNT ACC JOIN RETAIL_BANKING.CUSTOMER_MASTER C ON ACC.CLIENT_ID=CM.CLIENT_ID;

FIG. 17C shows the newly-built table 1752 created on the cloud 1704. Another PDP may include a dashboard 1754 which can provide a meaningful display of the data from the newly built table 1752. Particularly, the data from the newly built table 1752 can be consumed by another PDP, namely a churn prediction model (not shown), which can also be automatically built by the apparatus 100. The data from the newly-built table 1752 and the output from the churn prediction model (which may be produced upon training) can be displayed via yet another automatically built PDP which includes the dashboard 1754. Thus, multiple PDPs can also be automatically built to produce the reply 190 to the user query 150.

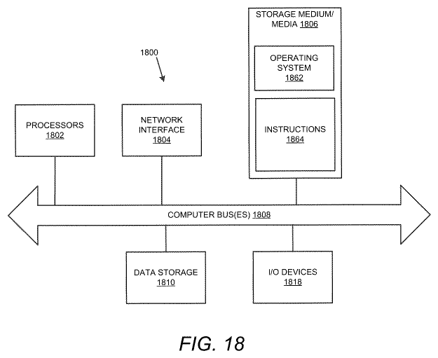

FIG. 18 illustrates a computer apparatus 1800 that may be used to implement desktops, laptops, smartphones, tablets, and wearables which may be used to generate or access the data from the AI-based data product provisioning apparatus 100 may have the structure of the computer apparatus 1800. The computer apparatus 1800 may include additional components not shown and that some of the process components described may be removed and/or modified. In another example, a computer apparatus 1800 can sit on external cloud platforms such as Amazon Web Services, AZURE® cloud or internal corporate cloud computing clusters, or organizational computing resources, etc.

The computer apparatus 1800 includes processor(s) 1802, such as a central processing unit, ASIC or another type of hardware processing circuit, input/output devices 1818, such as a display, mouse keyboard, etc., a network interface 1804, such as a Local Area Network (LAN), a wireless 802.11x LAN, a 3G, 4G or 8G mobile WAN or a WiMax WAN, and a processor-readable medium 1806. Each of these components may be operatively coupled to a bus 1808. The computer-readable medium 1810 may be any suitable medium that participates in providing instructions to the processor(s) 1802 for execution. For example, the processor-readable medium 1806 may be a non-transitory or non-volatile medium, such as a magnetic disk or solid-state non-volatile memory, or a volatile medium such as RAM. The instructions or modules stored on the processor-readable medium 1810 may include machine-readable instructions 1864 executed by the processor(s) 1802 that cause the processor(s) 1802 to perform the methods and functions of the AI-based data product provisioning apparatus 100.

The AI-based data product provisioning apparatus 100 may be implemented as software stored on a non-transitory processor-readable medium and executed by the one or more processors 1802. For example, the processor-readable medium 18018 may store an operating system 1862, such as MAC OS, MS WINDOWS, UNIX, or LINUX, and code 1864 for the AI-based data product provisioning apparatus 100. The operating system 1862 may be multi-user, multiprocessing, multitasking, multithreading, real-time, and the like. For example, during runtime, the operating system 1862 is running and the code for the AI-based data product provisioning apparatus 100 is executed by the processor(s) 1802.

The computer apparatus 1800 may include a data storage 1810, which may include non-volatile data storage. The data storage 1810 stores any data used by the AI-based data product provisioning apparatus 100. The data storage 1810 may be used to store the various user queries, data entities, training data used for training the different ML models, and other data that is used or generated by the AI-based data product provisioning apparatus 100 during the course of operation.

The network interface 1804 connects the computer apparatus 1800 to internal systems for example, via a LAN. Also, the network interface 1804 may connect the computer apparatus 1800 to the Internet. For example, computer apparatus 1800 may connect to web browsers and other external applications and systems via the network interface 1804.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed is:

1. An Artificial Intelligence (AI) based data product provisioning apparatus, comprising:
at least one hardware processor; and
at least one non-transitory processor-readable medium storing instructions for and the at least one hardware processor executing:
a user query analyzer that builds a conceptual data product (CDP) listing requirements from a user query requesting information that is to be generated by at least one physical data product (PDP);
a data product verifier that determines if the at least one PDP responsive to the user query exists in an enterprise data entity catalog that lists PDPs of a plurality of PDP types, wherein if the at least one PDP cannot be identified in the enterprise data entity catalog,
the data product verifier identifies a type of the at least one PDP, and
the data product verifier generates a logical data product (LDP) that represents data entities required to build the at least one PDP, wherein the LDP is generated based on the type of the at least one PDP to be built;
a data product builder that builds the at least one PDP by accessing the data entities identified in the LDP; and
an output generator that outputs as a reply to the user query, one of information from the at least one PDP and the at least one PDP.

2. The AI-based data product provisioning apparatus of claim 1, wherein the user query analyzer implements a Key Bidirectional Encoder Representations from Transformers (KeyBERT) technique for extracting context-based keywords.

3. The AI-based data product provisioning apparatus of claim 2, wherein the user query analyzer further generates an enhanced search query by combining the context-based keywords.

4. The AI-based data product provisioning apparatus of claim 3, wherein the user query analyzer determines if the at least one PDP responsive to the user query exists in the enterprise data entity catalog by:
applying cosine similarity to the context-based keywords and contents of the enterprise data catalog; and
applying sequence matching between the context-based keywords and contents of the enterprise data entity catalog; and
comparing with respective thresholds to results of the cosine similarity and the sequence matching.

5. The AI-based data product provisioning apparatus of claim 3, wherein the data product verifier generates the LDP by:
applying natural language processing (NLP) for tag based searching of the data entities; and
extracting entity relationships and features of the data entities.

6. The AI-based data product provisioning apparatus of claim 5, wherein the features include recency, rating, data veracity metrics, past user acceptance/rejection statistics, and asset type.

7. The AI-based data product provisioning apparatus of claim 5, wherein the data product verifier generates the LDP by further applying sentiment analysis to filter the data entities.

8. The AI-based data product provisioning apparatus of claim 5, wherein the LDP includes a knowledge graph with nodes representing the data entities and edges representing connections between the data entities.

9. The AI-based data product provisioning apparatus of claim 1, wherein the plurality of types of PDP include at least database tables, analytical models, and visualization dashboards.

10. The AI-based data product provisioning apparatus of claim 9, wherein to build the at least one PDP the data product builder generates a configuration file based on the type of PDP to be built, wherein the configuration file includes at least details of the data entities required to build the at least one PDP.

11. The AI-based data product provisioning apparatus of claim 10, wherein to build the at least one PDP, the data product builder:
automatically creates code from the configuration file.

12. The AI-based data product provisioning apparatus of claim 11, wherein the at least one PDP to be built includes at least one of the database tables and the data product builder:
automatically creates the code including Data Definition Language (DDL) and Data Manipulation Language (DML) statements; and
creating and storing the database table in a target database by automatically executing the DDL and DML statements on the target database.

13. The AI-based data product provisioning apparatus of claim 11, wherein the at least one PDP to be built is one of the visualization dashboards and the data product builder:
automatically creates the code including application commands associated with an application to build the visualization dashboard; and
automatically executes the application commands to create and store the visualization dashboard on a target platform.

14. The AI-based data product provisioning apparatus of claim 11, wherein the PDP to be built is one of the analytical models and the data product builder:
automatically creates the code including a framework with a machine learning (ML) model and feature list; and
provides access to the ML model for training, wherein the reply to the user query is generated by the trained ML model.

15. An Artificial Intelligence (AI) based method of automatically provisioning data products including:
generating an enhanced user query from a received user query, wherein the received user query includes requirements for information to be provided by a physical data product (PDP);
retrieving mapped search results from a plurality of data sources using the enhanced user query, wherein the mapped search results include one or more of data products and data entities that constitute the data products;
extracting features of the mapped search results;
determining based on the features, that the PDP responsive to the user query is not stored on the plurality of data sources;
identifying a type of the PDP to be built based at least on the enhanced user query;
automatically generating a logical data product (LDP) for building the PDP, wherein the LDP includes one or more of the data entities required for building the PDP;
automatically generating a configuration file for the PDP using natural language processing (NLP) on the LDP;
automatically generating the code for building the PDP from the configuration file; and
building the PDP by executing the code on a target platform; and
providing access to one of the PDP and an output of the PDP as a reply to the user query.

16. The AI-based method of automatically provisioning data products of claim 15, wherein determining that the PDP responsive to the user query is not stored in the plurality of data sources further includes:
training a multi-class classification model on labeled training data including user queries expressing different informational needs and a set of different types of PDPs, wherein each PDP of the set of different types of PDPs is marked as responsive to corresponding one of the user queries; and
providing the mapped search results to the multi-class classification model.

17. The AI-based method of automatically provisioning data products of claim 15, wherein generating the LDP for building the PDP further includes:
obtaining a set of the data entities from the mapped search results that are qualified for building the PDP.

18. The AI-based method of automatically provisioning data products of claim 17, wherein automatically generating the code for building the PDP from the configuration file further includes:
automatically creating the code including Data Definition Language (DDL) and Data Manipulation Language (DML) statements when the PDP includes a table;
automatically creating the code including application commands associated with an application to build a visualization dashboard, when the PDP to be built includes the visualization dashboard; and
automatically creating the code including a framework with a machine learning (ML) model and feature list wherein the PDP to be built includes the ML model.

19. A non-transitory processor-readable storage medium storing machine-readable instructions for and a processor executing:
a user query analyzer that builds a conceptual data product (CDP) listing requirements from a user query requesting information that is to be generated by at least one physical data product (PDP);
a data product verifier that determines if the at least one PDP responsive to the user query exists in an enterprise data corpus that stores PDPs of a plurality of PDP types, wherein if the at least one PDP cannot be identified in the enterprise data corpus,
the data product verifier identifies a type of the at least one PDP, and
the data product verifier generates a logical data product (LDP) that represents data entities required to build the at least one PDP, wherein the LDP is generated based on the type of the at least one PDP to be built;
a data product builder that builds the at least one PDP by accessing the data entities identified in the LDP; and
an output generator that outputs as a reply to the user query one of information from the at least one PDP and the at least one PDP.

20. The non-transitory processor-readable storage medium of claim 19, including further instructions that cause the processor to:
receive user feedback to the reply; and
fine tune parameters of a plurality of machine learning (ML) models accessed by the data product verifier based at least on the user feedback.
